(19) United States
(12) Patent Application Publication
(10) Pub. No.: US 2012/0052912 A1
(43) Pub. Date: Mar. 1, 2012

(54) METHOD FOR CALLING PHONE NUMBER AND MOBILE PHONE USING THE SAME

(75) Inventor: JUN LI, Shenzhen City (CN)

(73) Assignees: CHI MEI COMMUNICATION SYSTEMS, INC., Tu-Cheng (TW); SHENZHEN FUTAIHONG PRECISION INDUSTRY CO., LTD., ShenZhen City (CN)

(21) Appl. No.: 13/006,436

(22) Filed: Jan. 14, 2011

(30) Foreign Application Priority Data
Aug. 30, 2010 (CN) 201010266705.X

(51) Int. Cl. H04W 88/02

(52) U.S. Cl. 455/558

(57) ABSTRACT

A method for calling a phone number is used on a mobile phone capable of receiving a first subscriber identity module (SIM) card and a second SIM card. The mobile phone may correlate the phone number with either of the first SIM card and the second SIM card. A display of the mobile phone may display a shortcut option indicating to call the phone number with either of the first SIM card and the second SIM card which is correlated with the phone number.

### BACKGROUND

1. Technical Field

The present disclosure relates to a method for calling phone number and a mobile phone using the same.

2. Description of Related Art

A dual subscriber identity module (SIM) mobile phone generally holds two SIM cards. The dual SIM mobile phone is often provides a “Dual SIM Dual Standby” function in which two active SIM cards can be accessed simultaneously, using only one transceiver. To call a specific phone number using a specific one of the two SIM cards, the user must remember to use the specific one of the two SIM cards whenever calling the specific phone number. Such operation is inconvenient.

### BRIEF DESCRIPTION OF THE DRAWINGS

FIG. 1 is a block diagram of one embodiment of a mobile phone.

FIG. 2 is a block diagram of one embodiment of a control system shown in FIG. 1.

FIG. 3 is a flowchart illustrating one embodiment of a first stage of a method for calling a phone number on a mobile phone.

FIG. 4 is a flowchart illustrating one embodiment of a second stage of the method for calling the phone number on the mobile phone.

FIG. 5 is an exemplary operation displayed on the mobile phone of FIG. 1.

### DETAILED DESCRIPTION

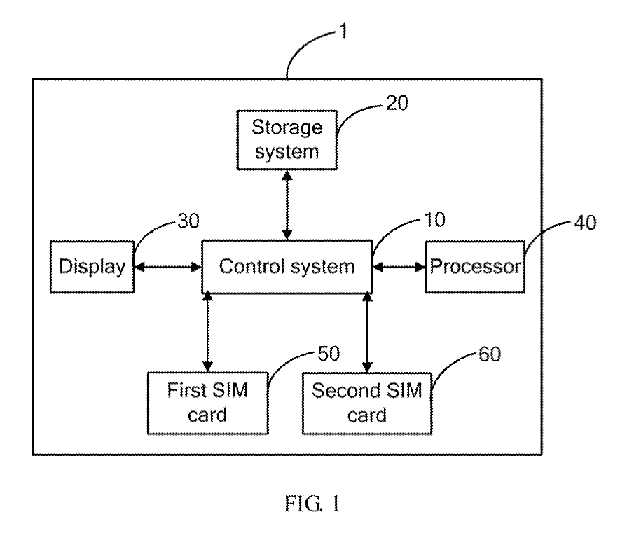

FIG. 1 is a block diagram of one embodiment of a mobile phone 1. The mobile phone 1 includes a control system 10, a storage system 20, a display 30, and a processor 40. The mobile phone 1 is capable of receiving a first subscriber identity module (SIM) card 50 and a second SIM card 60. The storage system 20 may be a memory unit. A phone number may be stored in the storage system 20, the first SIM card 50, or the second SIM card 60 for requirements. The display 30 may be a LCD screen or a touch screen, for example.

In general, the word “module” as used herein, refers to logic embodied in hardware or firmware, or to a collection of software instructions, written in a programming language, such as, for example, Java, C, or assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as either software and/or hardware unit and may be stored in any type of computer-readable medium or other computer storage device.

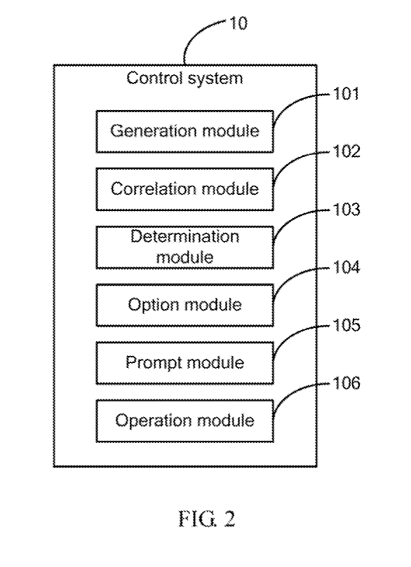

FIG. 2 is a block diagram of the control system 10 shown in FIG. 1. The control system 10 includes a generation module 101, a correlation module 102, a determination module 103, an option module 104, a prompt module 105, and an operation module 106. The modules 101-106 may comprise computerized code in the form of one or more programs that are stored in the storage system 20. The computerized code includes instructions that are executed by the processor 40 to provide functions for the modules 101-106.

The generation module 101 is operable generate a shortcut option, which can be used to call the phone number using either of the first SIM card 50 and the second SIM card 60 which is correlated with the phone number. The correlation module 102 is operable to correlate the phone number with either of the first SIM card 50 and the second SIM card 60. The determination module 103 determines whether the phone number has been correlated with either of the first SIM card 50 and the second SIM card 60. The option module 104 may display the shortcut option on the display 30, indicating to the user an option to call the phone number using either of the first SIM card 50 and the second SIM card 60 which is correlated with the phone number. The display module 104 further displays a first option and a second option on the display 30, individually indicating to call the phone number using the first SIM card 50 and the second SIM card 60.

The prompt module 105 displays a prompt on the display 30, indicating to correlate the phone number with either of the first SIM card 50 and the second SIM card 60. The prompt module 105 further displays a prompt on the display 30, indicating to store the phone number in the storage system 20 when the shortcut option is modified by a user. The operation module 106 calls the phone number based on the shortcut option.

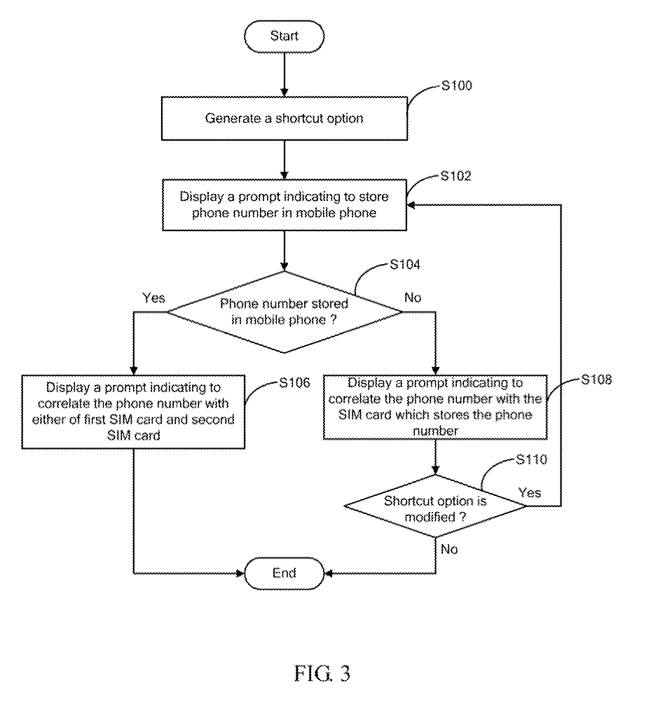

FIG. 3 is a flowchart illustrating a first stage of a method for calling the phone number on the mobile phone 1. Depending on the embodiment, additional blocks in the flow of FIG. 3 may be added, others removed, and the ordering of the blocks may be changed.

In block S100, the generation module 101 generates the shortcut option, which can be used to call the phone number using either of the first SIM card 50 and the second SIM card 60 which is correlated with the phone number.

In block S102, the prompt module 105 displays a prompt indicating to store the phone number in the storage system 20 of the mobile phone 1.

In block S104, the determination module 103 determines whether the phone number is stored in the storage system 20. If the phone number is stored in the storage system 20, in block S106, the prompt module 105 displays a prompt on the display 30, indicating to correlate the phone number with either of the first SIM card 50 and the second SIM card 60.

If the phone number is not stored in the storage system 20, in block S108, the prompt module 105 displays a prompt on the display 30, indicating to correlate the phone number with either of the first SIM card 50 and the second SIM card 60 which stores the phone number. Particularly, the phone number should be correlated with the first SIM card 50 if the phone number is stored in the first SIM card 50. The phone number should be correlated with the second SIM card 60 if the phone number is stored in the second SIM card 60.

In block S110, the determination module 103 determines whether the shortcut option is modified by the user. If the shortcut option is modified by the user, block S102 is repeated. If the shortcut option is not modified by the user, the process is complete.

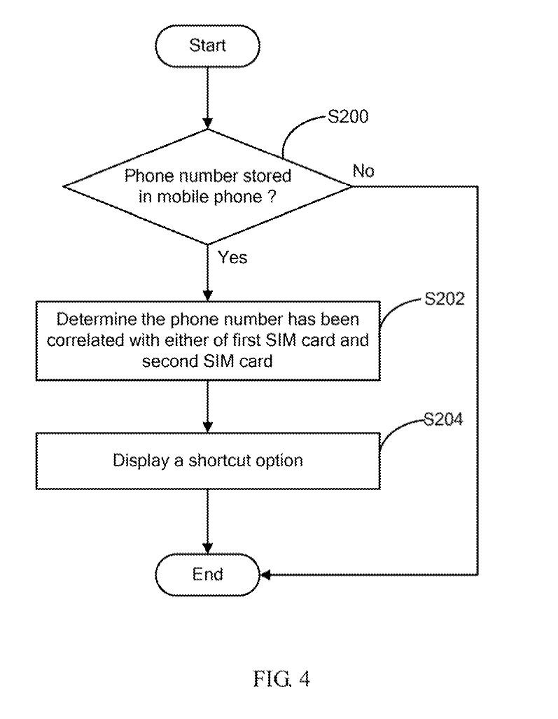

FIG. 4 is a flowchart illustrating a second stage of a method for calling the phone number on the mobile phone 1. Depending on the embodiment, additional blocks in the flow of FIG. 4 may be added, others removed, and the ordering of the blocks may be changed.

In block S200, the determination module 103 determines whether the phone number is stored in the storage system 20 of the mobile phone 1. If the phone number is not stored in the storage system 20, the process is complete.

If the phone number is stored in the storage system 20, in block S202, the determination module 103 determines the phone number has been correlated with either of the first SIM card 50 and the second SIM card 60.

In block S204, the option module 104 displays the shortcut option on the display 30.

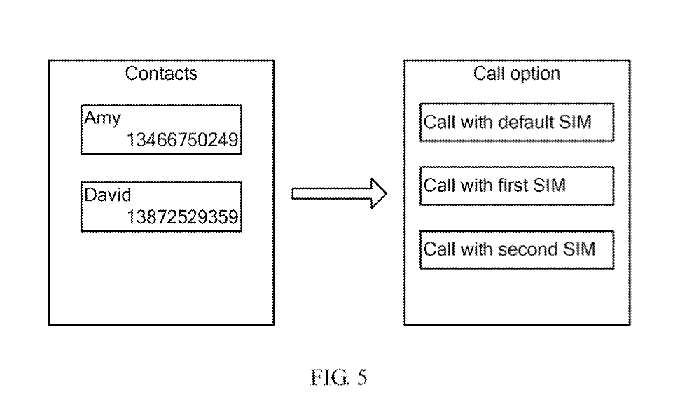

FIG. 5 is an exemplary operation displayed on the mobile phone 1 of FIG. 1. The display 30 may display an option “Call with default SIM”, an option “Call with first SIM”, and an option “Call with second SIM” when the phone number stored in the storage system 20 is called. The shortcut option indicates the option “Call with default SIM”. The first option indicates the option “Call with first SIM”. The second option indicates the option “Call with second SIM”.

The present disclosure provides a method for calling phone number on a dual SIM mobile phone. A user may call specific phone number without remembering to use specific one of two SIM cards held in the dual SIM mobile phone. The user experience is improved.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method for calling a phone number on a mobile phone, the mobile phone capable of receiving a first subscriber identity module (SIM) card and a second SIM card, the method comprising:
correlating the phone number with either of the first SIM card and the second SIM card;
generating a shortcut option that indicates to call the phone number using either of the first SIM card and the second SIM card which is correlated with the phone number; and
calling the phone number based on the shortcut option.

2. The method of claim 1, further comprising:
displaying a prompt on a display of the mobile phone indicating to correlate the phone number with either of the first SIM card and the second SIM card.

3. The method of claim 1, further comprising:
displaying a first option and a second option on a display of the mobile phone individually indicating to call the phone number using the first SIM card and the second SIM card.

4. A mobile phone capable of receiving a first subscriber identity module (SIM) card and a second SIM card, comprising:
a storage system;
at least one processor;
a display;
one or more programs stored in the storage system and being executable by the at least one processor, the one or more programs comprising:
a correlation module operable to correlate a phone number with either of the first SIM card and the second SIM card;
an option module operable to display a shortcut option on the display, indicating to call the phone number using either of the first SIM card and the second SIM card which is correlated with the phone number; and
an operation module operable to call the phone number based on the shortcut option.

5. The mobile phone of claim 4, further comprising a prompt module operable to display a prompt on the display, to correlate the phone number with either of the first SIM card and the second SIM card.

6. The mobile phone of claim 4, wherein the option module further displays a first option and a second option on the display, individually indicating to call the phone number using the first SIM card and the second SIM card.

7. A storage medium having stored thereon instructions that, when executed by a processor, causing the processor to perform a method for calling a phone number on a mobile phone, the mobile phone capable of receiving a first subscriber identity module (SIM) card and a second SIM card, wherein the method comprises:
correlate the phone number with either of the first SIM card and the second SIM card;
generate a shortcut option that indicates to call the phone number using either of the first SIM card and the second SIM card which is correlated with the phone number; and
call the phone number based on the shortcut option.

8. The storage medium of claim 7, wherein the method comprises:
display a prompt on a display of the mobile phone indicating to correlate the phone number with either of the first SIM card and the second SIM card.

9. The storage medium of claim 7, wherein the method comprises:
display a first option and a second option on a display of the mobile phone individually indicating to call the phone number using the first SIM card and the second SIM card.
